(19) United States
(12) Patent Application Publication
(10) Pub. No.: US 2009/0242329 A1
(43) Pub. Date: Oct. 1, 2009

(54) Sawhorse with Opposing Fixed and Moveable Sides

(76) Inventor: Kit Paul Edward Krauss, San Geronimo, CA (US)

Correspondence Address: STEVEN A. NIELSEN;ALLMAN & NIELSEN, P.C., 100 Larkspur Landing Circle, Suite 212, LARKSPUR, CA, 94939, US

(21) Appl. No.: 12/413,550

(22) Filed: Mar. 28, 2009

Related U.S. Application Data
(60) Provisional application No. 61/040,250, filed on Mar. 28, 2008.

(51) Int. Cl. B25H 1/06

(52) U.S. Cl. 182/153

(57) ABSTRACT

A foldable sawhorse 100 is supported by four legs F1, F2, M1, M2 attached directly under a horizontal work support piece 2. A horizontal notch 3 or void runs along the lower corner of the horizontal work support piece 2 on the fixed side of the sawhorse and accepts an upper cross member F3. The two legs F1, F2 on the fixed side are rigidly secured to the horizontal work support piece 2, the upper cross member F3 and two support brackets 6. Two or more barrel hinges 4 are placed under the horizontal work support piece 2 and each hinge 4 has a plate 5 secured to a fixed leg F1, F2 and a plate 6 secured to a moving leg M1, M2. An optional folding shelf structure F4, M4 may be secured upon the legs in a position lower than the horizontal work support piece 2. The sawhorse folds into a near flat configuration that is conveniently stackable with other sawhorses of the same configuration.

### RELATED PATENT APPLICATION AND INCORPORATION BY REFERENCE

This is a utility application based upon U.S. patent provisional application Ser. No. 61/040250, entitled “Sawhorse with Opposing Fixed and Moveable Sides” filed on Mar. 28, 2008. This related application is incorporated herein by reference and made a part of this application. If any conflict arises between the disclosure of the invention in this utility application and that in the related provisional application, the disclosure in this utility application shall govern. Moreover, the inventor incorporates herein by reference any and all patents, patent applications, and other documents hard copy or electronic, cited or referred to in this application.

### BACKGROUND OF THE INVENTION

(1) Field of the Invention

The invention generally relates to devices and methods of providing a working surface or structure useful in the construction industry. More particularly, the invention relates to means and methods of sawhorse construction.

(2) Description of the Related Art

Several attempts to create a useful folding sawhorse are known in the related art. For example, U.S. Pat. No. 6,164,413 FOLDING SAWHORSE issued on Dec. 26, 2000 to Sagol discloses a folding sawhorse with vertically adjustable extensions and dual pivots at or near the top work surface. U.S. Pat. No. 6,601,675 LOCKING FOLDABLE SAWHORSE issued on Aug. 5, 2003 to Gulledge discloses a sawhorse composed of two supporting frames connected to two pivoting top pieces.

The related art fails to provide a foldable sawhorse system wherein the work support member is rigidly attached to one side or leg frame while the opposing side pivots. Thus, there is a short fall in the art and a need in the art for the present invention.

### BRIEF SUMMARY OF THE INVENTION

The present invention overcomes shortfalls in the related art by presenting an unobvious and unique combination and configuration of components to produce a folding sawhorse system. The disclosed saw horse overcomes shortfalls in the art by disclosing a unique pivot system wherein one frame assembly or sawhorse side is permanently and creatively affixed to a top work support piece and wherein the opposite frame assembly or sawhorse side pivots into and away from the top work support piece. The disclosed configuration of components provides unexpected results in superior strength and stability. The disclosed configuration of components allows the sawhorse to fold into a flat position for efficient stacking and storage.

These and other objects and advantages will be made apparent when considering the following detailed specification when taken in conjunction with the drawings.

### BRIEF DESCRIPTION OF THE DRAWINGS

FIG. 1 is a perspective view of a sawhorse constructed in a manner consistent with the teachings of the invention.

FIG. 2 is a sectional view of an upper section of a sawhorse constructed in a manner consistent with the teachings of the invention.

FIG. 3 is an elevational view of a folded sawhorse constructed in a manner consistent with the teachings of the invention.

### REFERENCE NUMERALS IN THE DRAWINGS

F side parts may be found on the fixed side of the sawhorse while, some F parts may be rigidly secured to the horizontal work support piece 2 and/or support bracket F6.

M side may be found on the movable side of the sawhorse opposite to the fixed side

Parts M1 to M5 have analogous and corresponding parts F1 to F5

M1 leg—movable and on the moving side

M2 leg—movable and on the moving side

M3 upper cross member—supports moving legs M1, M2 and is not attached to the horizontal work support piece 2.

M4 half shelf—on the moving side, may be used with the other half-shelf F4 as a full shelf when the sawhorse 100 is in an extended position

M5 lower cross member

F1 leg—opposite to leg M2

F2 leg—opposite to leg M1

F3 upper cross member—provides extra support and stability by rigid connection into the notch 3 area, width surfaces 8 of the fixed legs F1, F2 and by attachment to support brackets F6

F4 half shelf

F5 lower cross member—of the fixed side or F side found opposite to the lower cross member M5 of the movable side or M side

F6 support bracket—found on either side of upper fixed cross member F3, in some embodiments there is right F6 support bracket and a left support bracket F6 such that the two support brackets are A-symmetrical having inside surfaces canting inwardly toward the center of the sawhorse

1 replaceable work surface—rests on top of the horizontal work support piece 2

2 horizontal work support piece—is provided with support by direct attachment to the four legs F1, F2, M1, M2

3 notch—in the horizontal lower corner section of horizontal work support piece 2, the notch 3 is used to accept the top edge and inside top section of the upper cross brace F3

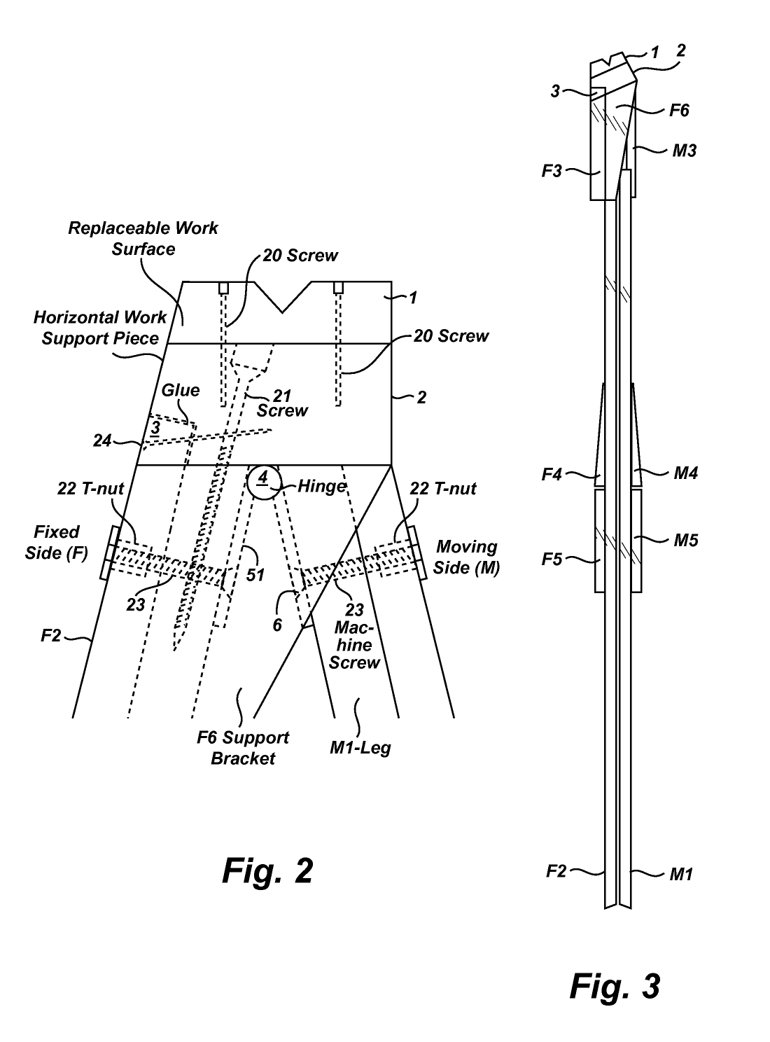

4 hinge barrel, shown in FIG. 2 with one plate 5 attached to fixed leg F2 and with the other plate 6 attached to moving leg M1, in some embodiments the plates 5, 6 are mortised into their respective fixed legs F1, F2 or moving legs M1, M2

5 hinge leaf on fixed side embedded into a fixed leg F1 or F2

6 hinge leaf on moving side embedded into a moving leg M1 or M2

7 depth surface found on outer edges of fixed legs F1 and F2, an upper section of the depth surface of fixed legs F1 and F2 is attached to a F6 support bracket

8 outer width surface found on fixed legs F1 and F2, an upper section of an outer width surface is attached to the fixed side upper cross member F3.

20 screw fastener

21 screw

22 T nut

23 machine screw

24 nail or screw used to secure upper cross member F3 to the notch 3 area of horizontal work support piece 2

100 a sawhorse constructed in accordance with the principles of the invention

glue area within notch 3 where glue may be used to secure upper cross member F3.

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

All the above references and U.S. patents and applications are incorporated herein by reference. Aspects of the invention can be modified, if necessary, to employ the systems, functions and concepts of the various patents and applications described above to provide yet further embodiments of the invention.

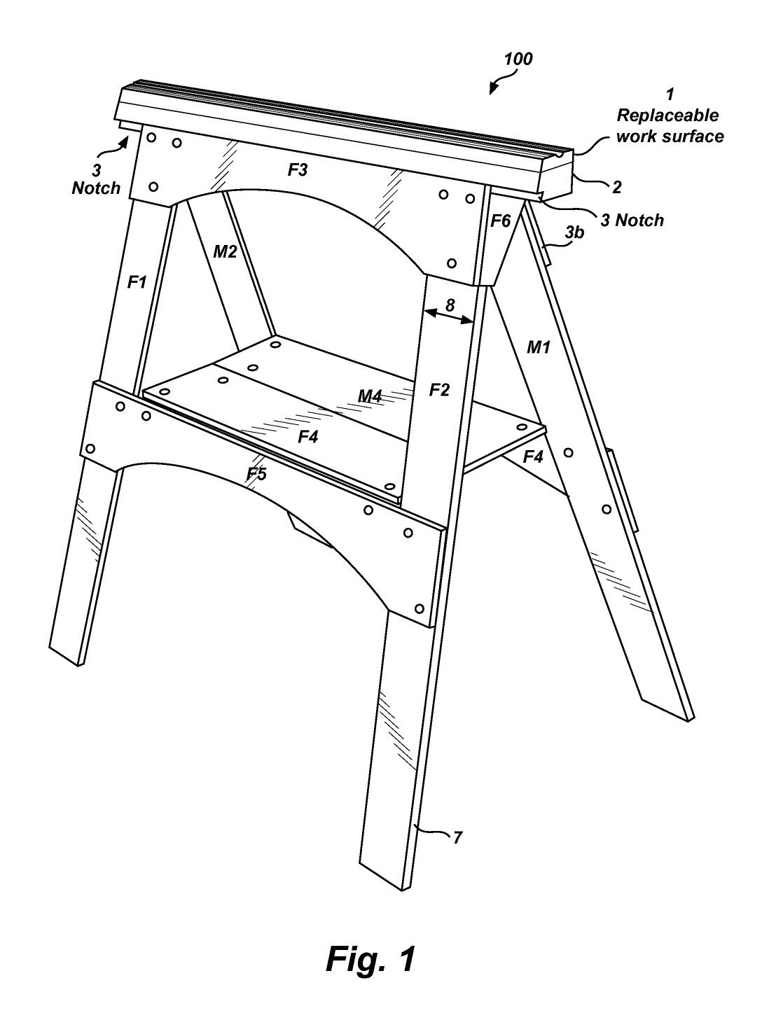

Referring to FIG. 1 a perspective view is presented wherein the sawhorse 100 is in an unfolded or extended position, ready to support work pieces upon the replaceable work surface 1. The sawhorse is also in position to accept a foreseeable misuse, wherein a user steps upon the half shelf comprised of a half shelf F4 on the fixed side or F side and a half shelf M4 on the moving side or M side.

The replaceable work surface 1 may be attached with one or more nails or screws 20 to the horizontal work support piece 2. A series of screws 21 may be driven and counter sunk into the horizontal work support piece 2 to attach fixed legs F1 and F2.

A notch 3, shown in FIG. 2 runs along the horizontal length of the horizontal work support piece 2. The notch 3 accepts the top edge of upper cross member F3 and fixed legs F1 and F2 are rigidly secured to cross member F3, horizontal work support piece 2 by use of a series of screws 21. Legs F1 and F2 are also rigidly secured by use and attachment to two support brackets F6 found on either outer edge of each rigid leg F1 and F2. As shown in FIG. 2, a support bracket F6 is attached to a horizontal work support piece 2, upper cross member F3, and one fixed leg, either F2 or F3. The shape of support bracket F6 is well shown in FIG. 3 where the sawhorse is shown in a folded position.

Referring to FIG. 1, on the fixed side, below the fixed upper cross member F3, the lower cross member F5 is secured to fixed legs F1 and F2. Half shelf F4 is connected by a hinge to lower cross member F5 and is connected by a hinge to opposing half shelf M4. Referring to FIG. 1 on the moveable side, lower cross member M5 is secured by legs M1 and M2. Half shelf M4 is attached with a hinge to lower cross member F3 and is also attached with a hinge to opposing half shelf F4.

Referring to FIG. 2, barrel hinge 4 rests at the bottom of horizontal work support piece 2 and rests in-between leg F2 and leg M1. In the preferred embodiment, the hinge plate 5 on the fixed side and the hinge plate 6 on the moving side are mortised into a leg. A second barrel hinge, not shown is configured in identical fashion between legs F1 and M2.

Referring to FIG. 2, T-nuts 22 may be used to secure each upper cross member F3 or M3, into its adjacent leg. T-nuts 22 may also be used to secure each lower cross member F5 and M5 to their adjacent legs.

In the sectional view presented in FIG. 2, a view of notch 3 is seen at the lower left side of horizontal work support piece 2. Upper cross member F3 may be fastened into the notch 3 by use of a screw or nail 24 and/or glue in the area marked as glue in FIG. 2. The area on the near horizontal plane of the notch is marked as Glue and in the preferred embodiment, construction glue with a relatively thick viscosity is placed in the near horizontal plane of the notch 3 so as to fill in possible voids between the horizontal work support piece 2 and the upper cross member F3 on the fixed side. In the preferred embodiment, the remaining points or areas of attachment of the components of the sawhorse are secured with standard exterior glue and in some cases also secured with a screw, nail, machine screw and/or T-nut.

Referring to FIG. 3, legs F2 and M1 are shown in a folded position and an elevational view is presented. Half shelves F4 and M4 are resting in a vertical position above lower cross members F5 and M5. The edge of upper cross member M3 is exposed and is adjacent to support bracket F6 which covers the edge of upper cross member F2. Horizontal work support piece 2 is attached at the notch area 3 and by attachment to support bracket F6. Replaceable work surface 1 is attached to the top of Horizontal work support piece 2.

The four legs of the sawhorse F1, F2, M1, M2 directly support and stabilize the horizontal work support piece 2. All four legs are attached directly to the bottom most surface of the horizontal work support piece 2. The upper cross member F3 with its top end integrated into the notch 3 of the horizontal work support piece 2 and attached to either support bracket F6 and attached to both fixed legs F1, F2 helps to give the saw horse unexpected strength and stability.

These and other changes can be made to the invention in light of the above detailed description. In general, the terms used in the following claims, should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

While certain aspects of the invention are presented below in certain claim forms, the inventor contemplates the various aspects of the invention in any number of claim forms. Accordingly, the inventor reserves the right to add additional claims after filing the application.

The invention includes, but is not limited to the following items:

Item 1. A folding sawhorse comprising:
a) two folding legs M1 & M2 and two fixed legs F1 and F2;
b) a lower cross member F5 securing the two fixed legs F1 and F2 in a near parallel position such that the two fixed legs F1 and F2 are closer to one another at the top as compared to the bottom;
c) a lower cross member M5 securing the two movable legs M1 & M2 in near parallel position such that the two movable legs M1 and M2 are closer to one another at the top as compared to the bottom;
d) a first half shelf F4 attached by one or more hinges to the lower cross member F5 of the fixed legs F1 & F2, the half shelf F4 further attached with one or more hinges to a second half shelf M4, and the second half shelf M4 attached to the lower cross member M5 adjacent to the moving legs M1 & M2,
e) an upper cross member F3 secured to the two fixed legs F1 & F2 and further secured into a notch area 3 contained within a horizontal work support piece 2 and further secured by two support brackets F6;
f) the fixed support legs F1 & F2 being generally rectangular in shape, having an upper top surface and having an outer width surface 8 facing outwardly and attached to upper and lower cross members F3 & F5 and the fixed support legs further having a depth surface 7 facing laterally with part of the upper depth surface 7 attached to support brackets F6 found on either end of the horizontal work support piece 2; and
g) wherein two hinge barrels 4 are positioned under the horizontal work support piece, and wherein each hinge barrel as a first plate 5 mortised into a fixed support leg F1 or F2 and each hinge barrel has a second plate 6 mortised into a moving support leg M1 or M2 so as to allow the moving support legs to fold next to the fixed support legs.

Item 2. The sawhorse of item 1 wherein all for legs F1, F2, M1, M2 are attached directly to the bottom most surface of the horizontal work support piece 2.

Item 3. The sawhorse of item 2 wherein the support brackets F6 are A-symmetrical with inside portions canting inwardly where such portions come into contact with the upper portions of the depth surface 7 of either fixed leg F1 or F2.

Item 4. The sawhorse of item 3 wherein:
a) fastening adhesive of a relatively thick viscosity is placed between an upper edge of the fixed upper support assembly and the near horizontal area of the notch 3 found along the length of the horizontal work support piece 2; and
b) fastening adhesive of a relatively thin viscosity is placed between the remaining points of contact of the components of the sawhorse 100.
Item 5. The saw horse of item 1 wherein the two barrel hinges 4 have each of their two leafs 5 and 6 mortised into a fixed leg F1, F2 or a moving leg M1, M2.

Item 6. A method of constructing a folding saw horse 100 with a fixed side F that is attached to a horizontal work support piece 2 and a replaceable work surface 1, the method comprising:
a) securing two fixed legs F1, F2 to a lower cross support F5 and an upper cross support F3;
b) securing an upper edge running along the length of the upper cross support F3 into a void area defined by a notch 3 running along a bottom length of a horizontal work support piece 2;
c) securing two support brackets F6 on either side of the outer upper depth surfaces 7 of the fixed support legs F1, F2, and further securing the two support brackets F6 to the outer ends of the upper cross member and to the lowermost surface of the horizontal work support piece 2.
d) securing a replaceable work surface 1 upon the top of the horizontal work support piece;
e) securing two moveable legs M1, M2 with a lower cross member M5 and an upper cross member M3; and
f) placing two barrel hinges 4 at the bottom of the horizontal work support piece 2 and securing a leaf 5 from the hinges into each fixed leg, F1 F2 and securing a leaf 6 from the hinges into each movable leg M1 M2.

Item 7. The method of item 6, further comprising the steps of:
using one or more hinges to secure the fixed lower cross member F5 to a first half shelf F4 which in turn is secured with one or more hinges to a second half shelf M4 and wherein the second half shelf is secured with one or more hinges to the lower cross member M5 used to secure the moving legs M1 M2.

Item 8. The method of item 7, further comprising the steps of:
creating a canted angle on the inside portions of each support bracket F6, so as to make each support bracket F6 A-symmetrical, thus requiring the use of a right support bracket F6 and a left support bracket F6.

Item 9. The method of item 7, further comprising the steps of:
a) positioning the fixed set of legs F1 F2 and moving set of legs M1 M2 such that each leg is angled inwardly such that the bottom of each leg is positioned directly under either end of the horizontal work support piece 2 and such that the top of each leg is positioned two to six inches from either end of the horizontal work support piece 2; and
b) positioning each leg F1, F2, M1, M2 directly under the bottom most portion of the horizontal work support piece 2.

What is claimed is:

1. A folding sawhorse comprising:
a) two folding legs and two fixed legs;
b) a lower cross member securing the two fixed legs and in a near parallel position such that the two fixed legs are closer to one another at the top as compared to the bottom;
c) a lower cross member securing the two movable legs in a near parallel position such that the two movable legs are closer to one another at the top as compared to the bottom;
d) a first half shelf attached by one or more hinges to the lower cross member of the fixed legs, the first half shelf further attached with one or more hinges to a second half shelf and the second half shelf attached to the lower cross member adjacent to the moving legs;
e) an upper cross member secured to the two fixed legs and further secured into a notch area contained within a lower outer section of a horizontal work support piece and further secured by two support brackets;
f) the fixed support legs being generally rectangular in shape, having an upper top surface and having an outer width surface facing outwardly and attached to upper and lower cross members and the fixed support legs further having a depth surface facing laterally with part of the upper depth surface attached to support brackets found on either end of the horizontal work support piece; and
g) wherein two hinge barrels are positioned under the horizontal work support piece, and wherein each hinge barrel as a first plate mortised into a fixed support leg and each hinge barrel has a second plate mortised into a moving support leg so as to allow the moving support legs to fold next to the fixed support legs.

2. The sawhorse of claim 1 wherein all four legs are attached directly to the bottom most surface of the horizontal work support piece.

3. The sawhorse of claim 2 wherein the support brackets are A-symmetrical with inside portions canting inwardly where such portions come into contact with the upper portions of the depth surface of either fixed leg.

4. The saw horse of claim 3 wherein:
a) fastening adhesive of a relatively thick viscosity is placed between an upper edge of the fixed upper support assembly and the near horizontal area of the notch found along the length of the horizontal work support piece; and
b) fastening adhesive of a relatively thin viscosity is placed between the remaining points of contact of the components of the sawhorse.

5. The sawhorse of claim 1 wherein the two barrel hinges have each of their two leafs mortised into a fixed leg or moving leg.

6. A method of construction a folding saw horse with a fixed side that is attached to a horizontal work support piece the method comprising:
a) securing two fixed legs to a lower cross support and an upper cross support;
b) securing an upper edge running along the length of the upper cross support into a void area defined by a notch running along a bottom length of a horizontal work support piece;
c) securing two support brackets on either side of the outer upper depth surfaces of the fixed support legs and further securing the two support brackets to the outer ends of the upper cross member and to the lowermost surface of the horizontal work support piece;
d) securing a replaceable work surface upon the top of the horizontal work support piece;
e) securing two moveable legs with a lower cross member and an upper cross member; and
f) placing two barrel hinges at the bottom of the horizontal work support piece and securing a leaf from the hinges into each fixed leg and securing a leaf from the hinges into each movable leg.

7. The method of claim 6, further comprising the steps of:
using one or more hinges to secure the fixed lower cross member to a first half shelf which in turn is secured with one or more hinges to a second half shelf and wherein the second half shelf is secured with one or more hinges to the lower cross member used to secure the moving legs.

8. The method claim 7, further comprising the steps of:
creating a canted angle on the inside portions of each support bracket, so as to make each support bracket A-symmetrical, thus requiring the use of a right support bracket and a left support bracket.

9. The method of claim 7, further comprising the steps of:
a) positioning the fixed set of legs and moving set of legs such that each leg is angled inwardly such that the bottom of each leg is positioned directly under either end of the horizontal work support piece and such that the top of each leg is positioned two to six inches from either end of the horizontal work support piece; and
b) positioning each leg directly under the bottom most portion of the horizontal work support piece.
